(19) United States
(12) Patent Application Publication
(10) Pub. No.: US 2026/0350430 A1
(43) Pub. Date: Nov. 5, 2026

(54) SYSTEMS AND METHODS FOR AN ANALYTIC PLATFORM

(71) Applicant: Fidelity Information Services, LLC, Jacksonville, FL (US)

(72) Inventor: Ranadhir GHOSH, St. Johns, FL (US)

(21) Appl. No.: 19/194,294

(22) Filed: Apr. 30, 2025

(51) Int. Cl. G06N 5/025; G06F 16/22; G06F 40/20

(52) U.S. Cl. CPC G06N 5/025; G06F 16/2237; G06F 40/20

(57) ABSTRACT

Systems and methods are disclosed for constructing a data model using an analytic platform. One method may include receiving a data project, the data project including a solution request, determining, based on the solution request, a first data set from one or more data repositories, accessing the one or more data repositories to locate data of the first data set, storing the first data set in one or more data repositories, processing the first data set to provide for processed data, constructing, by a trained machine learning model, a data model based on the processed data and the solution request, determining a solution based on the constructed data model and the solution request, and automatically providing the solution and the constructed data model to one or more applications.

### TECHNICAL FIELD

The present disclosure relates generally to systems and methods for an analytic platform and, more particularly, to systems and methods for constructing data models using an analytic platform in response to a data project request.

### BACKGROUND

As technology continues to advance, data continues to accumulate. While the amount of data which is available allows for solving complicated problems, accessing and processing large amounts of data may be challenging. Incompatibility issues may cause errors as data is often stored across multiple data repositories, on different storage mediums, and are accessed by different APIs. Other challenges may include accessing and processing data with inconsistent data formats, varying update frequencies, and differing access protocols. These nuances introduce inefficiencies like time-consuming data wrangling, the potential for mismatched or incompatible files, and an increased risk of errors, all of which may delay or prevent utilizing data to provide solutions or information.

There exists a need for a platform that can process large amounts of data types in different data repositories and construct data models in response to different types of data projects. The present disclosure is directed at overcoming one or more of these above-referenced challenges.

### SUMMARY OF THE DISCLOSURE

In some aspects, the techniques described herein relate to a computer-implemented method for constructing a data model using an analytic platform, the method including: receiving a data project, the data project including a solution request; determining, based on the solution request, a first data set from one or more data repositories; accessing the one or more data repositories to locate data of the first data set; storing the first data set in one or more data repositories; processing the first data set to provide for processed data; constructing, by a trained machine learning model, a data model based on the processed data and the solution request; determining a solution based on the constructed data model and the solution request; and automatically providing the solution and the constructed data model to one or more applications.

In some aspects, the techniques described herein relate to a system for constructing a data model using an analytic platform, the system including: a data storage device storing instructions for in an electronic storage medium; and a processor configured to execute the instructions to perform a method including: receiving a data project, the data project including a solution request; determining, based on the solution request, a first data set from one or more data repositories; accessing the one or more data repositories to locate data of the first data set; storing the first data set in one or more data repositories; processing the first data set to provide for processed data; constructing, by a trained machine learning model, a data model based on the processed data and the solution request; determining a solution based on the constructed data model and the solution request; and automatically providing the solution and the constructed data model to one or more applications.

In some aspects, the techniques described herein relate to a non-transitory machine-readable medium storing instructions that, when executed by a computing system, cause the computing system to perform a method for constructing a data model using an analytic platform, the method including: receiving a data project, the data project including a solution request; determining, based on the solution request, a first data set from one or more data repositories; accessing the one or more data repositories to locate data of the first data set; storing the first data set in one or more data repositories; processing the first data set to provide for processed data; constructing, by a trained machine learning model, a data model based on the processed data and the solution request; determining a solution based on the constructed data model and the solution request; and automatically providing the solution and the constructed data model to one or more applications.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts an exemplary environment for constructing a data model in response to a data project request, according to one or more embodiments.

FIGS. 1B and 1C depict an ingestion module and storage model, according to one or more embodiments.

FIGS. 1D and 1E depict an enrichment module and serve module, according to one or more embodiments.

FIG. 2 depicts a diagram of an exemplary method for constructing a data model using an analytic platform, according to one or more embodiments.

FIG. 3 depicts an example of a computing device, according to one or more embodiments.

### DETAILED DESCRIPTION OF EMBODIMENTS

Various embodiments of the present disclosure relate generally to systems and methods for an analytic platform and, more particularly, to systems and methods for constructing data models using an analytic platform in response to a project request.

According to certain aspects of the disclosure, methods and systems are disclosed for accessing different types of data across multiple data repositories to provide a solution model using an analytics platform. Conventional techniques may not be suitable for accessing numerous amounts of differing data because conventional techniques, among other things, are unable to synchronize data formats, perform necessary accessing protocols for each data storage type, and filter unnecessary data in order to provide a customized solution for a data modeling project. Manual data processing and lack of real-time analytics may result in slow decision-making. Conventional systems would need to go through this process repeatedly for each project request without leveraging previous project requests or machine learning. Accordingly, improvements in technology relating to data accessing and processing, as well as data construction modeling are needed.

Conventional systems may encounter issues related to accessibility. For example, data may be stored in in separate systems, repositories, or data silos, which might not be easily accessible or integrated, leading to fragmented insights. Security policies and access controls may vary between repositories, limiting who can access what data and slowing down collaboration. Retrieving data from remote or overloaded sources can introduce delays, making it harder to work with real-time or large-scale datasets.

Conventional systems may also encounter issues related to processing. For example, conventional systems may encounter issues related to data inconsistency. Different repositories may store similar data in varying formats, units, or structures, making it difficult to align and compare datasets. In addition, data dispersed across different platforms limits holistic insights.

Variations in data schemas (field names, types, or relationships) across repositories can complicate data merging and require significant transformation efforts. Without consistent metadata, it's challenging to understand the context, lineage, or structure of the data, which hinders effective usage. Repositories may differ in how frequently they are updated or how rigorously data is validated, leading to potential trust issues or the need for extra cleaning. Multiple repositories may also contain overlapping datasets having different metadata. This may lead to confusion or errors in analysis if not properly deduplicated. In addition, different repositories may use different technologies (SQL vs NoSQL, cloud vs on-prem, etc.), requiring extra tooling or adapters for integration. Changes to data structures or contents in one repository might not be reflected in another, causing discrepancies or integration failures. Existing systems may not be equipped to support enterprise-scale AI/ML use cases and every new implementation, using conventional methods, may require creating, or recreating, a similar data pipeline. A system that is able to shortcut, or even bypass, model development for different type of client queries, would be beneficial in data problem solving techniques.

This disclosure provides systems and methods for constructing a data model using an analytic platform. The systems and methods may include receiving a data project, the data project including a solution request. The systems and methods may include determining, based on the solution request, required data from one or more data repositories. The systems and methods may include accessing the one or more data repositories to locate the required data. The systems and methods may include temporarily storing the required data in one or more data repositories. The systems and methods may include processing the required data. The systems and methods may include constructing a data model based on the processed data and the solution request. The systems and methods may include determining a solution based on the constructed data model and the solution request. The systems and methods may include delivering the solution and the constructed data model to one or more applications.

An end-to-end analytic platform that may integrate corporate data lakes and repositories for a common AI-powered analytics solution may include many advantages of conventional systems. Developing a scalable analytic platform that leverages artificial intelligence or machine learning (AI/ML) to integrate data across corporate data lakes and tools (e.g., Jira, GitHub), may enhance decision-making, streamline operations, and drive innovation through data insights. Key benefits may include improved efficiency, faster insights, scalable AI/ML applications, and integration across various enterprises.

The terminology used below should be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “data repository,” “data warehouse,” “data lake,” “database,” “data vault,” “data catalog,” and “data mart,” may be used to describe a centralized place where data is stored, managed, and maintained for future retrieval and use. These terms may generally describe large-scale data storage specifically designed for analytics and reporting, and aggregating data from multiple sources. A data lake may include a more flexible and scalable repository that stores raw, unstructured, semi-structured, or structured data in its native format. A database may include a structured repository that supports real-time querying and updates, usually used for operational data. A data archive may include long-term storage focused on historical data that is infrequently accessed. A data vault may include organized data with a focus on auditability and historical tracking. A data catalog may include a meta-repository that doesn't store data itself, but keeps track of what data exists, its structure, and how to access it. A data mart may include a subset of a data warehouse, often designed for a specific department or business function. Examples may include, but are not limited to, Amazon S3, Google Cloud Storage, Microsoft Azure Blob Storage, MySQL, PostgreSQL, Oracle DB, MongoDB, Cassandra, Couchbase, GitHub, GitLab, Dryad, Zenodo, GenBank.

As used herein, a “machine learning model” generally encompasses instructions, data, and/or a model configured to receive input, and apply one or more of an analysis on the input to generate an output. The output may include, for example, a constructed data model, a project data solution, and an analytic platform. The output may be based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, certain embodiments may use a machine learning model to respond to a data project request by analyzing the data required and the steps of the process to determine and construct a data model to provide a data solution. Certain embodiments may then utilize the constructed model for training of other data modeling techniques, or for providing future data solutions. Based on this, certain embodiments may generate merchant-specific data modeling for use in response to a data project solution request.

While several of the examples herein involve data repositories, it should be understood that techniques according to this disclosure may be adapted to any suitable type of data modeling techniques. It should also be understood that the examples herein are illustrative only. The techniques and technologies of this disclosure may be adapted to any suitable activity.

Presented below are various aspects of machine learning techniques that may be adapted for data construction and modeling. As will be discussed in more detail below, machine learning techniques adapted to generate a data modeling solution set may include one or more aspects according to this disclosure, e.g., a particular selection of training data, a particular training process for the machine learning model, operation of a particular device suitable for use with the trained machine learning model, operation of the machine learning model in conjunction with particular data, modification of such particular data by the machine learning model, etc., or other aspects that may be apparent to one of ordinary skill in the art based on this disclosure.

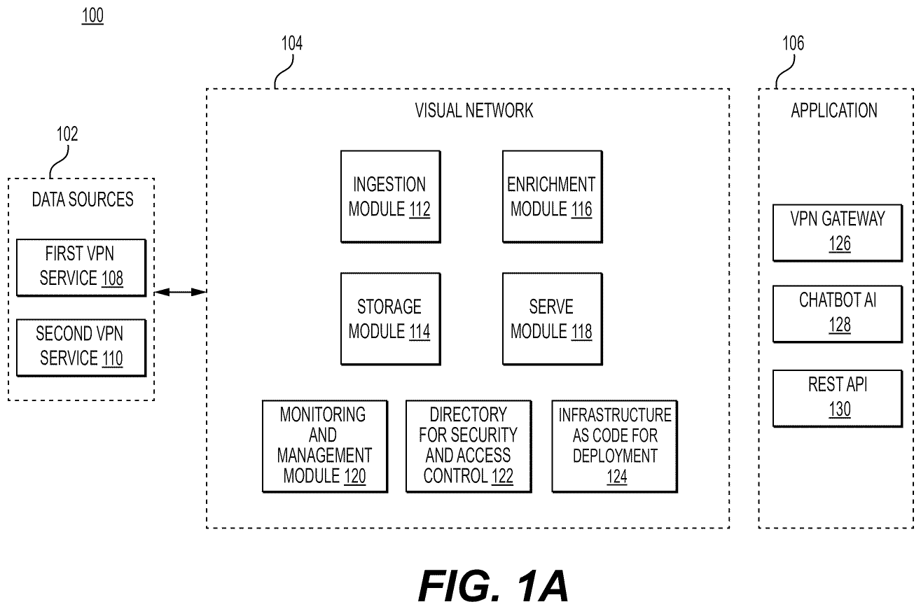

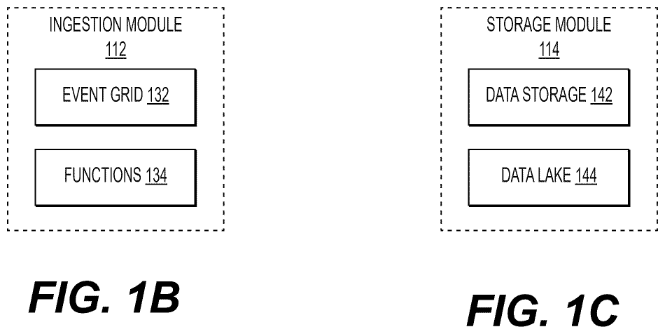

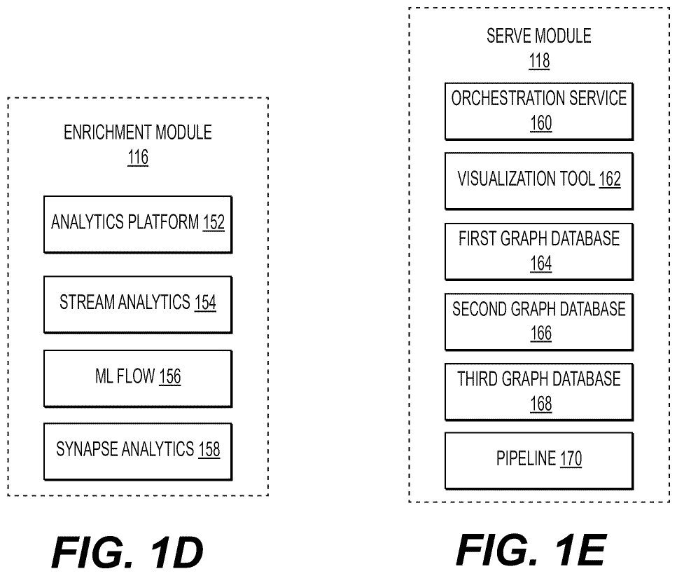

FIG. 1A includes an exemplary depiction of environment 100 for constructing a data model in response to a data project request, according to one or more embodiments. Environment 100 may be utilized with the techniques, including the systems and method presented herein. As FIG. 1A shows, environment 100 may include data sources 102, visual network 104, and application 106, communicating across a network. As discussed in further detail below, one or more server systems may communicate with one or more of the other components of the environment 100 across the network, also consisting of one or more servers. The systems and devices of environment 100 may communicate in any arrangement, including an arrangement other than what FIG. 1A illustrates.

Data sources 102 may include first VPN service 108 and second VPN service 110. First VPN service 108 and second VPN service 110 may provide a way for securely accessing one or more data lakes. In an exemplary embodiment, first VPN service 108 may include a VPN network used for enabling web traffic ingestion, and second VPN service 110 may include a VPN service for enabling in-house traffic.

Visual network 104 may include ingestion module 112, enrichment module 116, storage module 114, serve module 118, monitoring and management module 120, directory for security and access control 122, and infrastructure as code for deployment 124.

FIG. 1B depicts ingestion module 112 according to one or more embodiments. Ingestion module 112 may define how data is extracted, transformed, and loaded into a data storage system. Ingestion module 112 may include a structured approach to moving data from diverse sources into a central repository for analysis and utilization. Ingestion module 112 may also outline a process for collecting, cleaning, and preparing data for use in business intelligence, machine learning, or other application. Ingestion module 112 may include event grid 132 and functions 134. In an exemplary embodiment, event grid 132 may include Azure Event Grid and functions 134 may include Azure Functions that enhance data and utilize protocols such as HTTP/HTTPS.

FIG. 1C depicts storage module 114 according to one or more embodiments. Storage module 114 may include data storage 142 and data lake 144. Storage module 114 may include collecting, organizing, and preserving information in a centralized location for future purposes like analysis, sharing, and reporting, which will be described in greater detail below. Storage module 114 may include extracting, transforming, and loading data to integrate data from multiple sources. While storage module 114 typically includes temporary storage, such as for the duration of constructing a data model or determining a data solution set, storage module 114 may include storage of data for longer durations or permanent storage. In one exemplary embodiment, data storage 142 may include a data storage, such as Azure Data Lake that uses an ODBC protocol, and data lake 144 may include a delta lake, such as Azure Data Lake that uses an FTP protocol.

FIG. 1D includes a depiction of enrichment module 116 according to one or more embodiments of visual network 104 of FIG. 1A. Enrichment module 116 may include analytics platform 152, stream analytics 154, ML flow 156, and synapse analytics 158. In an exemplary embodiment, enrichment module 116 may include enhancing existing data by adding new or more detailed information. Enrichment module 116 may include augmenting a dataset with additional features or attributes, to make the data set richer and more valuable for analysis and decision-making.

In one exemplary embodiment, analytics platform 152 may include a unified, open analytics platform. Analytics platform 152 may also include building, deploying, sharing, and maintaining enterprise-grade data, analytics, and AI solutions.

In one exemplary embodiment, stream analytics 154 may include a fully managed stream processing engine designed to analyze and process large volumes of streaming data with minimal latencies. Stream analytics 154 may identity patterns and relationships in data that originates from various input sources including applications, devices, sensors, clickstreams, and social media feeds. Stream analytics 154 may also use these patterns to trigger actions and initiate workflows such as raising alerts, feeding information to a reporting tool, or storing transformed data for later use.

In one exemplary embodiment, ML flow 156, may include a framework designed to manage a machine learning lifecycle. The framework may be open-source or closed source. ML flow 156 may include running training routines that use a machine learning model. Additionally, ML flow 156 may use a tools to train and serve models on different platforms. ML flow 156 may also include a machine learning workspace that utilizes a tracking server for code to be ingested in ML flow 156.

In an exemplary embodiment, synapse analytics 158 may include an analytics service for accelerating the time it may take to discover insights across data warehouses and big data systems. Synapse analytics 158 may combine multiple structured query language (SQL) technologies used in enterprise data warehousing. Synapse analytics 158 may also include utilizing technologies for logging and time-series analyzing of large amounts of data.

FIG. 1E depicts serve module 118 according to one or more embodiments. Serve module 118 may include orchestration service 160, visualization tool 162, first graph database 164, second graph database 166, third graph database 168, and pipeline 170. Serve module 118 may include providing service security, manageability, and availability, by automating the management of certain network pathways of a subnet. Serve module 118 may include configuring the subnet, its associated network security group, and route table to contain a set of required entries. Serve module 118 may include the point at which the automatic configuration of a model takes effect.

In one exemplary embodiment, orchestration service 160 may include a managed service used to write micro services, or to deploy and manage containerized applications. Managing containerized applications may include reducing the complexity and operational overhead by offloading certain responsibilities. Orchestration service 160 may also include deploying and managing containerized applications that require high availability, scalability, and portability, and for deploying applications to multiple regions, such as by using open-source tools and integrating with existing development tools.

In one exemplary embodiment, visualization tool 162 may include connecting data sources, such as software services, apps, and connectors, in a manner to visualize and discover important features. Visualization tool 162 may also include storing the visualizations or important features via a database such as first graph database 164, second graph database 166, and third graph database 168. While three different graph databases are shown, it is possible to have more or less than three graph databases. In addition, each knowledge graph may include different access levels, or may be customized based on different needs.

In one exemplary embodiment, pipeline 170 may include automatically building or testing code projects. Pipeline 170 may include continuously integrating and continuously delivering code to one or more destinations. In another exemplary embodiment, pipeline 170 may also automate model builds and make model available to end-users in an efficient and secure manner.

Referring back to FIG. 1A, visual network 104 may include monitoring and management module 120. In an exemplary embodiment, monitoring and management module 120 may include a log storage and query resource which may be used construct infrastructure-level and application-level solutions. Besides storage and query of log data., monitoring and management module 120 may also serve as a layer in addition to log analytics aimed at application telemetry and to provide additional features to help construct better models and operate well-used data infrastructures.

In an exemplary embodiment, directory for security and access control 122 may include identity and access management (IAM). Directory for security and access control 122 may also securely manage user identities, authentication, and authorization for cloud resources. In another exemplary embodiment, directory for security and access control 122 may include a central directory for managing who has access, what they have access to, and how they may access it.

In an exemplary embodiment, infrastructure as code for deployment 124 may include defining and deploying data model infrastructures, such as networks, virtual machines, load balancers, and connection topologies. In addition, infrastructure as code for deployment 124 may also include ensuring, when required, that a model is constructed in the same environment every time it is deployed. For example, infrastructure as code for deployment 124 may enforce consistency by representing desired environment states using documented code in formats such as JSON. These deployments may be repeatable and prevent runtime issues caused by configuration drift or missing dependencies. In another exemplary embodiment, a deployment command may set the target environment into a same configuration, regardless of an environment's starting state by automatically configuring the existing target, or by discarding the existing target.

FIG. 1A also depicts application 106 including VPN gateway 126, chatbot AI 128, and REST API 130. According to an exemplary embodiment, VPN gateway 126 may be used to send encrypted traffic between a virtual network over the public Internet. VPN gateway 126 may also be used to send encrypted traffic between virtual networks over a private network, such as a Microsoft network. VPN gateway 126 may use a specific type of virtual network gateway. In addition, VPN gateway 126 may include multiple connections created to the same virtual network gateway. In this instance, when creating multiple connections, VPN tunnels may share the available gateway bandwidth.

According to an exemplary embodiment, chatbot AI 128 may provide an integrated development environment for building a chatbot. For example, chatbot AI 128 may enable developers of to build conversational AI bots that may assist with constructing or accessing a data solution model. chatbot AI 128 may function using natural language processing without requiring any code from developers.

According to an exemplary embodiment, REST API 130, or representational State Transfer (REST) API, may include service endpoints to support sets of HTTP operations (methods). For example REST API 130 may provide, create, retrieve, update, or delete access to a service's resources. REST API 130 may include request-response pair as basic components. Specifically, REST API 130 may determine how to create and send a REST request, and may also determine how to handle responses.

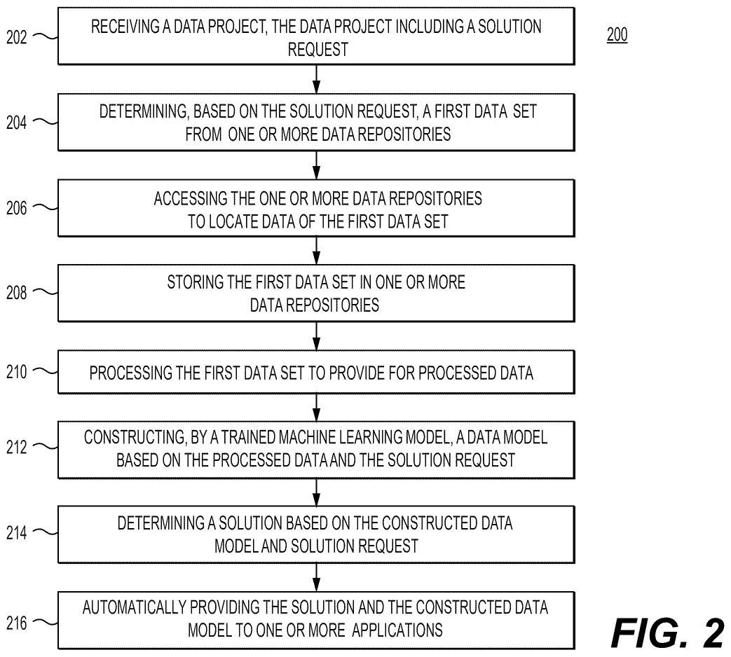

FIG. 2 includes an exemplary depiction of method 200 for constructing a data model using an analytic platform, according to one or more embodiments. In some embodiments, method 200 may include a step 202, receiving a data project, the data project including a solution request. A data project may include gathering data from various sources and drawing conclusions and identifying patterns in the data. A solution request may also include communicating or presenting findings through visualizations, reports, or other formats, or building predictive or descriptive models using the data. In general, a data project may require solving problems by identifying and addressing issues based on data analysis, or provide data-driven recommendations to help with making informed choices.

In some embodiments, method 200 may include a step 204, determining, based on the solution request, a first data set from one or more data repositories. According to an implementation, determining first data set from the one or more data repositories may include processing data requirements included in the solution request. In an exemplary embodiment, the first data set may include required data or specifically requested data. In another implementation, determining the first data set from the one or more data repositories may be determined by a machine learning model. The machine learning model may be trained based on one or more of historical or simulated solution request input values correlated with corresponding data sets. The training data may be tagged such that the machine learning model may correlate components, metadata, or other information from the solution request with the data set. The machine learning model may be improved iteratively, or in real-time by adjusting one or more layers, weights, biases, nodes and/or the like.

In some embodiments, method 200 may include a step 206, accessing the one or more data repositories to locate data of the first data set. In one exemplary embodiment, accessing the one or more data repositories may include methods such as logging in, or providing verification information. In another embodiment, accessing the one or more data repositories may require interacting with one or more APIs (Application Programming Interfaces). In another embodiment, a machine learning model may be trained on ways to access a variety of data repositories, either via providing verification information, accessing APIs, or any other means known in the art.

In some embodiments, method 200 may include a step 208, storing the first data set in one or more data repositories. The data repositories may already be created, such as a data repository already marked as a storage data repository. In an exemplary embodiment, the data repository bay be temporary storage. In another embodiment, a new data repositories may be created for storing the data set. A machine learning model may also be utilized, based on prior training data or historical training data, to determine how to store the first data set in the one or more data repositories. For example, a machine learning model may perform any of the following data storage processes: determining a location for storage, creating the storage destination, executing the transfer or mapping of the first data set to the storage destination, providing metadata associated with the data set.

In one exemplary embodiment, storing required data may include a volatile memory, such as cache. Alternatively, storing the required data in one or more data repositories may include using variables, such as within an application, to store data within a program's memory. For example, JavaScript variables may provide tools for storing data temporarily in variables within a browser. In another exemplary embodiment, key-value stores may be used for storing key-value pairs and may be suitable for storing simpler data structures. Oher techniques such as relational databases, cloud storage, or other storage methods may also be utilized.

In some embodiments, method 200 may include a step 210, processing the first data set. Processing the data set may include formatting the data so that it may be readable, or consistent with other data. For example, processing the data set may also include cleaning, organizing, and preparing the raw data by identifying and correcting errors, inconsistencies, and redundancies, handling missing values, transforming data into a suitable format (e.g., standardizing, normalizing), reducing data dimensionality, and enriching the data with external sources if required. Processing data may also include ensuring the collected data is accurate and complete.

Processing the data set may also include embedding the data. In an exemplary embodiment, embedding the data may include transforming various data types—such as text, images, or other complex data—into a structured, numerical format that can be readily processed and analyzed by a machine learning model and machine learning algorithms. In another exemplary example, natural language processing (NLP) may be used to enhance the understanding of text in tasks like sentiment analysis, machine translation, and data classification.

In another exemplary embodiment, processing the data set may include creating a vector database for retrieval of the processed data. For example, a vector database may be created for storing, indexing, and querying the data set via multi-dimensional vector data, or vector embeddings. A vector database, as will be discussed below, may be utilized to construct a data model. For example, a constructed model may connect with a vector database to retrieve results or determine a solution by accessing the vector database to return the most similar vectors along with their associated metadata, enabling applications to leverage the semantic relationships captured by the vector embeddings.

In another exemplary embodiment, a vector database may be created by a machine learning model. A machine learning model may be trained based on training or historical data to create a vector database. For example, a trained machine learning model may convert raw data into vector embeddings that are then stored, indexed, and queried within a vector database.

In some embodiments, method 200 may include a step 212, constructing, by a trained machine learning model, a data model based on the processed data and the solution request. In an exemplary embodiment, constructing a data model may involve defining objectives, determining entities and attributes of the data, and establishing relationships between entities across different sources. A logical model may be created, including data types, relationships, constraints, ensuring data integrity, and applying normalization if needed. For example, a constructed data model may include selecting a solution, creating a database schema, and loading transformed data for data validation and testing.

In some embodiments, constructing a data model, by a trained machine learning model may include receiving, as training data, a plurality of solution requests and a plurality of data models associated with the plurality of solution requests, and training a machine learning model with the training data, to construct a data model. For example, training a machine learning model may include feeding the model data to learn relationships between solution requests as inputs and data models as outputs. The process may include providing input data of features (raw information) related to solution requests and data models, along with output labels, such as in a supervised learning model, or without labels, such as in an unsupervised learning model.

Training a machine learning model may include learning algorithms that process the data and adjust internal parameters. The adjustments may be performed to minimize the difference between predictions and actual labels, such as in a supervised learning model, or to discover patterns, such as in an unsupervised learning model. This iterative optimization may involve calculating accuracy or efficiencies, adjusting parameters, and evaluating model performance. Additionally, hyperparameters, which may control the learning process, may be tuned for an optimal machine learning model performance. A trained machine learning model may represent the learned patterns and may be capable of making predictions on new, or unseen data related to constructing a data model. The trained model's performance may be evaluated on a separate dataset to assess its ability to generalize new data and provide a constructed data model effectively.

In another exemplary embodiment, constructing a data model may include creating a knowledge graph based on the processed data and constructing the data model further based on the created knowledge graph. A knowledge graph may include identifying a specific knowledge domain and types of entities and relationships to be represented. For example, a knowledge graph may identify the key entities (nodes) and their relationships (edges) within the knowledge domain, and use a semantic data model to develop queries that explore the data and retrieve relevant information based on the relationships within the graph. In one exemplary embodiment, a graph may help determine relationships between a data solution request and the data required, the protocol necessary to access the data, the location of the data, API access, etc. Suh a knowledge graph may be regularly update with new data to refine the model as needed to ensure its accuracy and relevance.

In some embodiments, method 200 may include a step 214, determining a solution based on the constructed data model and the solution request. In an exemplary embodiment, constructing a data model may include assessing the solution based on a predetermined threshold, iteratively modifying the constructed data model until the constructed data model equals or exceeds the predetermined threshold, and providing an updated solution based on the constructed data model equaling or exceeding the predetermined threshold. A predetermined threshold may include a percentile-based thresholds. For example, a solution may need to be 95% or greater in order to be labeled as a solution. A predetermined threshold may also be based on a ranking. For example, if a constructed data model results in ten solutions, a predetermined threshold for a constructed model may include the top two models as acceptable data solution models. In another exemplary embodiment, determining a solution may include assessing the solution based on a predetermined threshold, such as the predetermined threshold examples provided above. An updated solution may be provided after the iterative modifying process results in the constructed model equaling or exceeding the predetermined threshold.

In some embodiments, method 200 may include a step 216, automatically providing the solution and the constructed data model to one or more applications. Each application may have different displays, UI interfaces, API requirements/protocols, etc. In general, providing a solution and the constructed data model may include displaying the solution or the constructed data to a user for downloading or automatically initiating the transmission of the solution or constructed data model to another application for display.

Overall, this flowchart represents a scalable, secure platform for future AI/ML applications where operational efficiency improvements may be realized via process automation. This approach may produce data visualization and reporting for enhanced insights, along with improved agility with AI-driven insights that may result in cost savings through automation and optimized resource utilization.

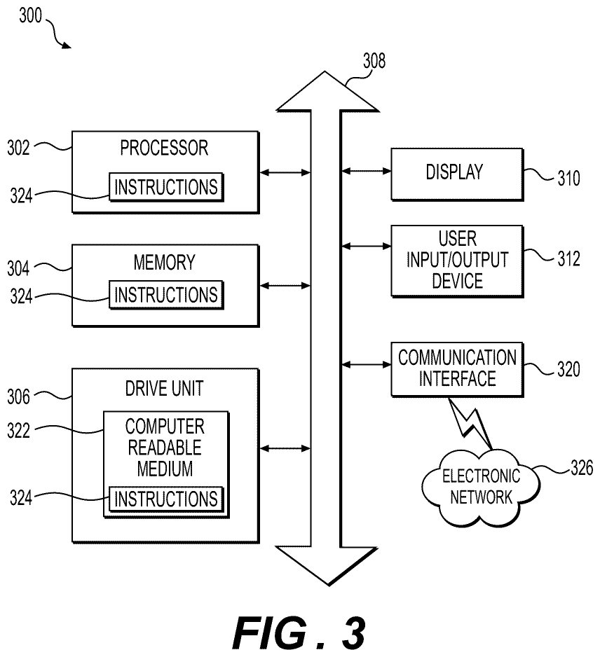

FIG. 3 depicts an example of a computer system, according to one or more embodiments. Computer system 300 may be utilized with the techniques and methods presented herein, such as in FIGS. 1, 1A-1E, and 2. It is to be understood that computer system 300 need not necessarily be performed in the exact order described herein and the steps described herein may be rearranged in some embodiments. Further, in some embodiments fewer than all steps of method 200 may be performed and in some embodiments additional steps may be performed.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

In general, any process or operation discussed in this disclosure that is understood to be computer-implementable, such as the systems or devices in the environment 100 of FIGS. 1A-1E, or any of the processes illustrated in FIG. 2, may be performed by one or more processors of a computer system as described herein. A process or a process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1A-1E. One or more processors of a computer system may be included in a single computing device or distributed among a multitude of computing devices. A memory of the computer system may include the respective memory of each computing device of the plurality of computing devices.

FIG. 3 is a simplified functional block diagram of a computer system 300 that may be configured as a device for executing the methods of FIG. 2, according to exemplary embodiments of the present disclosure. For example, FIG. 3 illustrates an implementation of a computer system that may execute techniques presented herein. The computer system 300 can include a set of instructions that can be executed to cause the computer system 300 to perform any one or more of the methods or computer-based functions disclosed herein. The computer system 300 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action or processes of a computer or computing system, or similar electronic computing device, that manipulate or transform data represented as physical, such as electronic, quantities into other data similarly represented as physical quantities.

In a similar manner, the term “processor” may refer to any device or portion of a device that processes electronic data, e.g., from registers or memory to transform that electronic data into other electronic data that, e.g., may be stored in registers or memory. A “computer,” a “computing machine,” a “computing platform,” a “computing device,” or a “server” may include one or more processors.

In a networked deployment, the computer system 300 may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 300 may be implemented using electronic devices that provide voice, video, or data communication. Further, while the computer system 300 is illustrated as a single system, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. The processor 302 may be a component in a variety of systems. For example, the processor 302 may be part of a standard personal computer or a workstation. The processor 302 may be one or more processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 may include a cache or random-access memory for the processor 302. In alternative implementations, the memory 304 is separate from the processor 302, such as a cache memory of a processor, the system memory, or other memory.

The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the FIGs. or described herein may be performed by the processor 302 executing the instructions stored in the memory 304. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the computer system 300 may include an input/output device 312 configured to allow a user to interact with any of the components of the computer system 300. The input/output device 312 may be a number pad, a keyboard, or a cursor control device, such as a mouse, or a joystick, touch screen display, remote control, or any other device operative to interact with the computer system 300.

The computer system 300 may also or alternatively include drive unit 306, implemented as a disk or optical drive. The drive unit 306 may include a computer-readable medium 322 in which a set of instructions 324, e.g., software, can be embedded. Further, set of instructions 324 may embody one or more of the methods or logic as described herein. The set of instructions 324 may reside completely or partially within the memory 304 or within the processor 302 during execution by the computer system 300. The memory 304 and the processor 302 also may include computer-readable media as discussed above.

In some systems, computer-readable medium 322 includes the set of instructions 324 or receives and executes the set of instructions 324 responsive to a propagated signal so that a device connected to electronic network 326 can communicate voice, video, audio, images, or any other data over electronic network 326. Further, the set of instructions 324 may be transmitted or received over the electronic network 326 via communication port or interface 320, or using bus 308. The communication port or interface 320 may be a part of the processor 302 or may be a separate component. The communication port or interface 320 may be created in software or may be a physical connection in hardware.

The communication port or interface 320 may be configured to connect with electronic network 326, external media, the display 310, or any other components in computer system 300, or combinations thereof. The connection with the electronic network 326 may be a physical connection, such as a wired Ethernet connection or may be established wirelessly as discussed below. Likewise, the additional connections with other components of the computer system 300 may be physical connections or may be established wirelessly. The electronic network 326 may alternatively be directly connected to the bus 308.

While the computer-readable medium 322 is shown to be a single medium, the term “computer-readable medium” may include a single medium or multiple media, such as a centralized or distributed database, or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 300 may be connected to electronic network 326. The electronic network 326 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The electronic network 326 may include wide area networks (WAN), such as the Internet, local area networks (LAN), campus area networks, metropolitan area networks, a direct connection such as through a Universal Serial Bus (USB) port, or any other networks that may allow for data communication.

The electronic network 326 may be configured to couple one computing device to another computing device to enable communication of data between the devices. The electronic network 326 may generally be enabled to employ any form of machine-readable media for communicating information from one device to another. The electronic network 326 may include communication methods by which information may travel between computing devices.

The electronic network 326 may be divided into sub-networks. The sub-networks may allow access to other components connected thereto or the sub-networks may restrict access between the components. The electronic network 326 may be regarded as a public or private network connection and may include, for example, a virtual private network or an encryption or other security mechanism employed over the public Internet, or the like.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

The present embodiments encompass collecting and analyzing user or customer data, such as mobile device data, vehicle, smart or autonomous data, vehicle telematics data, home telematics data, smart home data, smart appliance data, etc. associated with the user or customer devices or computing devices. Such data may be collected and analyzed once the user or customer affirmatively opts into a program, such as a customer loyalty or rewards program, or the customer otherwise affirmatively consents to data being generated by their devices being utilized, collected, or analyzed.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in a temporary configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. The term “exemplary” is used in the sense of “example” rather than “ideal.” In this disclosure, the term “based on” means “based at least in part on.”

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The term “exemplary” is used in the sense of “example” rather than “ideal.” The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for constructing a data model using an analytic platform, the method comprising:
receiving a data project, the data project including a solution request;
determining, based on the solution request, a first data set from one or more data repositories;
accessing the one or more data repositories to locate data of the first data set;
storing the first data set in one or more data repositories;
processing the first data set to provide for processed data;
constructing, by a trained machine learning model, a data model based on the processed data and the solution request;
determining a solution based on the constructed data model and the solution request; and
automatically providing the solution and the constructed data model to one or more applications.

2. The computer-implemented method of claim 1, wherein the trained machine learning model has been trained by:
receiving, as training data, a plurality of solution requests and a plurality of data models associated with the plurality of solution requests;
training a machine learning model, using the training data, to construct one or more data models; and
providing the trained machine learning model for constructing the data model.

3. The computer-implemented method of claim 1, further comprising:
assessing the solution based on a predetermined threshold;
iteratively modifying the constructed data model until the constructed data model equals or exceeds the predetermined threshold; and
providing an updated solution based on the constructed data model equaling or exceeding the predetermined threshold.

4. The computer-implemented method of claim 1, further comprising:
creating a knowledge graph based on the processed data; and
constructing the data model further based on the created knowledge graph.

5. The computer-implemented method of claim 1, wherein processing the first data set further comprises using natural language processing.

6. The computer-implemented method of claim 1, wherein processing the first data set further comprises at least one of formatting, embedding, or enriching the first data set data.

7. The computer-implemented method of claim 1, further comprising:
creating a vector database for retrieval of the processed data; and
constructing the data model further based on the vector database.

8. A system for constructing a data model using an analytic platform, the system comprising:
a data storage device storing instructions in an electronic storage medium for constructing a data model using an analytic platform; and
a processor configured to execute the instructions to perform a method including:
receiving a data project, the data project including a solution request;
determining, based on the solution request, a first data set from one or more data repositories;
accessing the one or more data repositories to locate data of the first data set;
storing the first data set in one or more data repositories;
processing the first data set to provide for processed data;
constructing, by a trained machine learning model, a data model based on the processed data and the solution request;
determining a solution based on the constructed data model and the solution request; and
automatically providing the solution and the constructed data model to one or more applications.

9. The system of claim 8, wherein the trained machine learning model has been trained by:
receiving, as training data, a plurality of solution requests and a plurality of data models associated with the plurality of solution requests;
training a machine learning model, using the training data, to construct one or more data models; and
providing the trained machine learning model for constructing the data model.

10. The system of claim 9, further comprising:
assessing the solution based on a predetermined threshold;
iteratively modifying the constructed data model until the constructed data model equals or exceeds the predetermined threshold; and
providing an updated solution based on the constructed data model equaling or exceeding the predetermined threshold.

11. The system of claim 8, further comprising:
creating a knowledge graph based on the processed data; and
constructing the data model further based on the created knowledge graph.

12. The system of claim 8, wherein processing the first data set further comprises using natural language processing.

13. The system of claim 8, wherein processing the first data set further comprises at least one of formatting, embedding, or enriching the first data set data.

14. The system of claim 8, further comprising:
creating a vector database for retrieval of the processed data; and
constructing the data model further based on the vector database.

15. A non-transitory machine-readable medium storing instructions that, when executed by a computing system, cause the computing system to perform a method for constructing a data model using an analytic platform, the method including:
receiving a data project, the data project including a solution request;
determining, based on the solution request, a first data set from one or more data repositories;
accessing the one or more data repositories to locate data of the first data set;
storing the first data set in one or more data repositories;
processing the first data set to provide for processed data;
constructing, by a trained machine learning model, a data model based on the processed data and the solution request;
determining a solution based on the constructed data model and the solution request; and
automatically providing the solution and the constructed data model to one or more applications.

16. The non-transitory machine-readable medium of claim 15, wherein the trained machine learning model has been trained by:
receiving, as training data, a plurality of solution requests and a plurality of data models associated with the plurality of solution requests;
training a machine learning model, using the training data, to construct one or more data models; and
providing the trained machine learning model for constructing the data model.

17. The non-transitory machine-readable medium of claim 16, further comprising:
assessing the solution based on a predetermined threshold;
iteratively modifying the constructed data model until the constructed data model equals or exceeds the predetermined threshold; and
providing an updated solution based on the constructed data model equaling or exceeding the predetermined threshold.

18. The non-transitory machine-readable medium of claim 15, further comprising:
creating a knowledge graph based on the processed data; and
constructing the data model further based on the created knowledge graph.

19. The non-transitory machine-readable medium of claim 15, wherein processing the first data set further comprises using natural language processing.

20. The non-transitory machine-readable medium of claim 15, wherein processing the first data set further comprises at least one of formatting, embedding, or enriching the first data set data.
